(19) United States
(12) Patent Application Publication
(10) Pub. No.: US 2004/0116122 A1
(43) Pub. Date: Jun. 17, 2004

(54) Enhancing reception using intercellular interference cancellation

(75) Inventors: Eldad Zeira, Huntington, NY (US); Ariela Zeira, Huntington, NY (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE

(21) Appl. No.: 10/666,374

(22) Filed: Sep. 18, 2003

Related U.S. Application Data
(60) Provisional application No. 60/412,269, filed on Sep. 20, 2002.

(51) Int. Cl. H04Q 7/20

(52) U.S. Cl. 455/445; 455/423; 455/425

(57) ABSTRACT

At least one desired communication signal is received by a receiver. The at least one desired communication signal is transmitted in a wireless format of a cell. A plurality of communication signals are received. Communication signals are selected from the plurality. The selected communication signals include each desired communication signal and at least one communication signal originating from another cell. A channel estimate is produced for each selected communication signal. Data is jointly detected for the selected communication signals.

### CROSS REFERENCE TO RELATED APPLICATION

This application claims priority from provisional patent application Serial No. 60/412,269, filed on Sep. 20, 2002, which is incorporated by reference as if fully set forth.

### FIELD OF INVENTION

The invention relates generally to wireless communication systems. In particular, the invention relates to reducing intercellular interference in such systems.

### BACKGROUND

Inter-cell interference is a problem in wireless systems. Inter-cell interference can occur as base station to wireless transmit/receive unit (WTRU), WTRU to WTRU or base station to base station interference. In base station to WTRU interference, a WTRU located neat the edge of its cell suffers from a high level of interference from the base stations of adjacent cell(s).

In WTRU to WTRU interference, with reference to FIG. 1, if two wireless transmit/receive units (WTRUs) 14₁, 14₂ are in close proximity but in neighboring cells, each of the WTRU uplink transmissions will interfere with downlink transmissions from the other WTRU taking place during the same timeslot. WTRU 14₁ uplink transmission U1 interferes with WTRU 14₂ downlink transmission D2. Likewise, WTRU 14₂ uplink transmission U2 interferes with WTRU 14₁ downlink transmission D1. Although the effective isotropic radiated power (EIRP) of WTRUs 14 is much less that base stations 12, the close proximity of the WTRUs 14 to each other may result in unacceptable interference. In base station to base station interference, a base station suffers interference from adjacent base stations in the same carrier or adjacent carriers. In many CDMA communication systems, intra-cell interference is largely mitigated due to the orthogonality of the downlink codes from the base station. In some CDMA systems, such as the UMTS time division duplex (TDD) for both wideband or narrowband, TSM and others, intra-cell interference cancellation is employed in the WTRU receiver. However, typically, such receiver implementations have the effect of emphasizing inter-cell interference. Accordingly, it is desirable to reduce inter-cellular interference.

### SUMMARY

At least one desired communication signal is received by a receiver. The at least one desired communication signal is transmitted in a wireless format of a cell. A plurality of communication signals are received. Communication signals are selected from the plurality. The selected communication signals include each desired communication signal and at least one communication signal originating from another cell. A channel estimate is produced for each selected communication signal. Data is jointly detected for the selected communication signals.

### BRIEF DESCRIPTION OF THE FIGURES

FIG. 1 is an illustration of cross cell interference.

FIGS. 2A-2D are illustrations of applications for an inter-cell interference cancellation receiver.

FIG. 3 is an illustration of an inter-cell interference cancellation receiver.

FIG. 4 is a flow chart of a preferred algorithm for inter-cell interference cancellation.

FIG. 5 is an illustration of an embodiment of an inter-cell interference cancellation receiver in a wideband code division multiple access communication system.

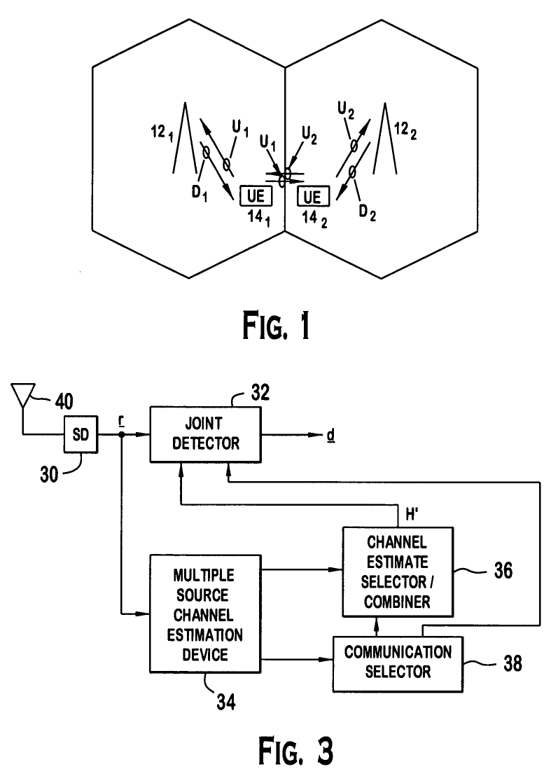

### DETAILED DESCRIPTION OF THE PREFERRED EMBODIMENTS

Hereafter, a wireless transmit/receive unit (WTRU) includes but is not limited to a user equipment, mobile station, fixed or mobile subscriber unit, pager, or any other type of device capable of operating in a wireless environment. When referred to hereafter, a base station includes but is not limited to a base station, Node-B, site controller, access point or other interfacing device in a wireless environment. An inter-cell interference canceller receiver can be applied to any wireless system having inter-cellular interference, such as UMTS TDD wideband or narrowband and TSM.

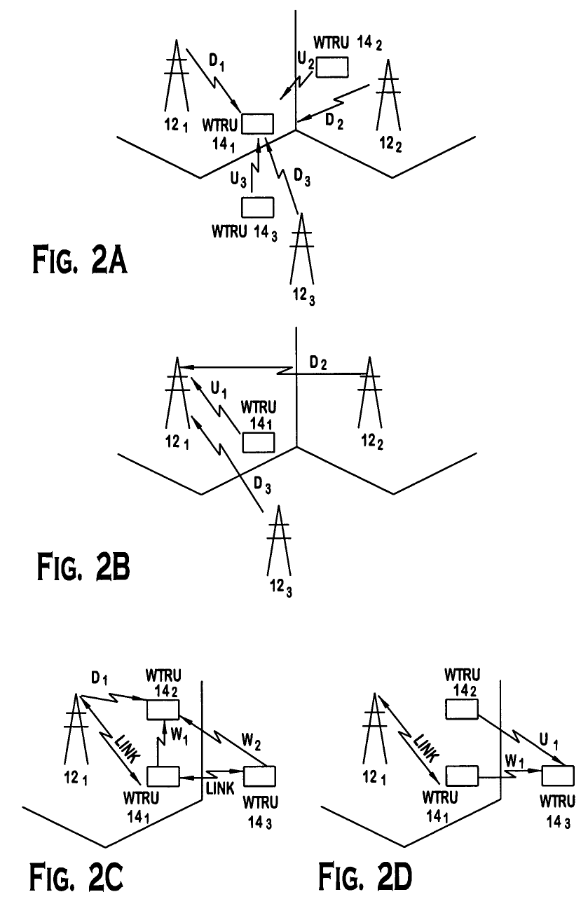

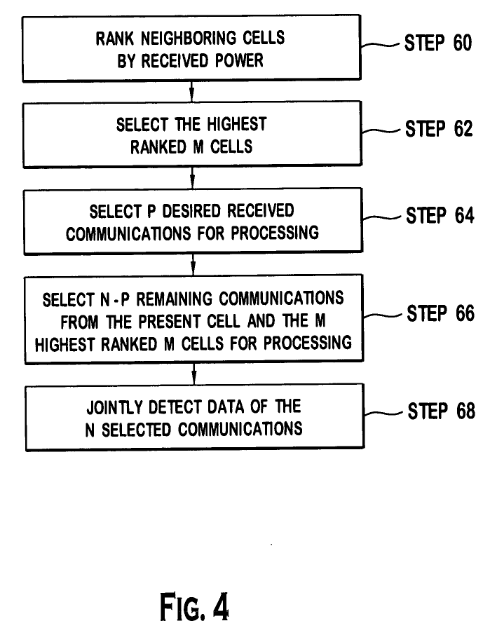

FIGS. 2A-2D are illustrations of environments where an inter-cell interference canceller can be utilized. Although the term cell is used in the following description, the term cell as follows is not limited to cellular systems. Inter-cell interference refers to interference from sources outside of the serving cell that a WTRU is connected. To illustrate in a wireless local area network environment, inter-cell interference refers to interference from cells other than the serving cell or other users serviced by that serving cell.

FIG. 2A illustrates a scenario where it is desirable to implement an intercell interference canceller receiver in a WTRU 14₁. The WTRU 14₁ is at the periphery of its cell. The WTRU 14₁ receives a desired downlink signal or signals, D1, from its base station 12₁. The WTRU 14₁ may also receive undesired signals from other cell's base stations 12₂, 12₃ and WTRUs 14₂, 14₃. As illustrated in FIG. 2A, the WTRU 14₁ receives the uplink signals, U2, U3, from neighboring WTRUs 14₂, 14₃ and downlink signals, D2, D3, from neighboring base stations 12₂, 12₃. Due to the close proximity of these undesired transmission sources, significant interference may result from these neighboring WTRUs 14₂, 14₃ and base stations 12₂, 12₃.

FIG. 2B illustrates a scenario where it is desirable to implement an inter-cell interference canceller receiver in a base station 12₁. The base station 12₁ receives a desired uplink signal or signals, U1, from one WTRU 14₁ or multiple WTRUs. The base station 12₁ may also receive undesired downlink signals, D2, D3, from other neighboring base stations 12₂, 12₃. The signals originating from these neighboring base stations 12₂, 12₃ may produce significant interference onto the uplink signal(s), U1.

FIGS. 2C and 2D illustrate other scenarios where it is desirable to implement an inter-cell interference canceller receiver in a WTRU. In FIG. 2C, a wireless communication link is established between a base station 12₁ and WTRU 14₁. To extend the operating range of the base station, in some wireless systems, WTRUs can communicate directly with each other, such as in an ad hoc mode. As shown in FIG. 2C, WTRU 14₁ and WTRU 14₃ have a communication link so that WTRU 14₃ can communicate with the base station 12₁ via WTRU 14₁. A WTRU 14₂ is located near WTRU 14₁. WTRU 14₂ receives a desired downlink communication from base station 14₂. The wireless link between WTRUs 14₁, 14₃ may interfere with WTRU 14₂ reception of D1. The WTRU to WTRU, W1, transmission from WTRU 14₁ and the WTRU to WTRU, W2, transmission from WTRU 14₃ may interfere with the downlink transmission, D1.

In FIG. 2D, WTRU 14₃ receives a desired WTRU to WTRU transmission, W1 from base station 12₁ via WTRU 14₁. The uplink transmission from WTRU 14₂ to base station 12₁ may interfere with W1. In each of these scenarios, the use of an inter-cell interference canceller may be used, potentially improving reception quality and, accordingly, cell capacity.

FIG. 3 is a simplified diagram of an inter-cell interference canceller receiver. An antenna 40 or antenna array receives desired communication signals, undesired communication signals and noise. The desired communication signals are communication signals assigned to the receiver for reception. The undesired communication signals are communication signals assigned to other receivers in the cell and other receivers outside of the cell. Signals in different cells, in some systems, may be differentiated by cell specific or WTRU specific scrambling codes. The combined received signal is sampled by a sampling device (SD) 30 producing a received vector, r. If the wireless communication system is a code division multiple access communication system, the sampling would typically be at the chip rate or a multiple of the chip rate.

A multiple source channel estimation device 34 estimates a channel response for each communication signal, possibly but not necessarily, using a reference signal, such as a pilot sequence or midamble sequence. A typical channel estimation device estimates the communications for channel signals of communications within its cell. To illustrate using the time division duplex (TDD) mode of the proposed third generation partnership project (3GPP) wideband code division multiple access (W-CDMA) communication system, a typical channel estimation device would utilize an implementation of the Steiner algorithm, which takes advantage of the relationship between the midamble sequences used in the cell. The multiple source channel estimation device 34 may have added complexity, since it estimates the channel response from multiple cells. Accordingly, the multiple source channel estimation device 34 may have more than one conventional channel estimation devices, such as one channel estimation device for each potential interfering cell.

Alternately, the number of cells analyzed is limited to a fixed number, such as two, three or four cells. The cells selected for analysis are based on their received signal power. To illustrate, an inter-cell interference canceller receiver is configured to analyze M cells. The receiver ranks the cells in order of received signal power. In addition to its serving cell, M-1 other cells are analyzed.

Using an output of the multiple source channel estimation device 34, a communication selector 38 selects communications for processing by the joint detector 32. Typically, the joint detector 34 is implemented to process a predetermined number of communications, such as N. In such a scenario, the communication selector 38 selects the desired communications, which the receiver must receive, such as P desired communications and N-P other communication signals. In certain implementations, the N-P other communication signals are the signals most likely to interfere with the desired signal, such as ranked by code or communication signal power, regardless of their cell or origination. The received signal power may be based on the combined received power of a symbol, if differing data rates are used, or over a specified time period, such as over sixteen chips.

In other implementations, the N-P other channel signals may include all of the receiver's serving cell communication signals and include codes/communications from other cells only if enough capacity is left (the total number of codes/communications is less than N). In some implementations, a threshold test may be used to reduce the number of communications processed to below N. In such an implementation, N communications are processed unless less than N communications exceed a predetermined threshold. Communication signals below the threshold are treated as being too insignificant to produce significant amounts of interference. In some joint detector designs, reducing the number of processed communications reduces the detector's complexity and improves its performance in the presence of noise.

In other implementations, the number of selected communications may vary. A threshold test may be used to determine the number of processed communications. The communications exceeding a threshold received power level are processed by the joint detector. An upper limit may be placed on the number of total communications processed. In some implementations, interfering communications may be known a priori. These communications may be known from a site survey or signaled by the network. In these implementations, the known interfering communications may be automatically selected.

In other implementation, the inter-cell interference cancellation may be selectively utilized. By selecting only channels used within the cell, the communication selector 38 effectively turns off the inter-cell interference cancellation and acts as a traditional channel estimator/joint detector receiver. To illustrate, if an efficient radio resource management algorithm is used, inter-cell interference may be negligible. In a W-CDMA TDD mode, the users of differing cells can be effectively separated by time slots. In such systems utilizing the additional hardware/software for inter-cell interference may be unnecessary. However, due to constraints on the available resources, even efficient radio resource algorithms may have to make trade-offs between total capacity and the isolation of users between cells. As a result, the inter-cell interference cancellation can be turned on to increase the overall system capacity by canceling such inter-cell interference. The turning-on of the inter-cell canceller may be controlled by signaling between the base station 12 and the WTRU 14 or the receiver may make its own determination when inter-cell interference is cancelled, such as based on interference measurements or other cell channel received power measurements.

Based on the selected communications, a channel estimate selector/combiner 36 produces channel estimates for the selected communications, such as in a channel response matrix H′. Typically, either a row or a column of the matrix H′ corresponds to one of the selected communications. A joint detector 32 receives an indication of the selected communications and the channel responses for those communications and performs a joint detection on the communications, producing data for each communication, such as a data vector d. The joint detector 32 may have various implementations, such as parallel interference cancellers (PIC), successive interference cancellers (SIC), zero forcing block linear equalizers (ZF-BLE), minimum mean square error block linear equalizers (MMSE-BLE) and combination implementations. In certain implementations, the entire data vector, d, may not need to be detected, such as in SIC. In these implementations, the joint detection can be ended after the last desired received communication signal is processed.

FIG. 4 is a flow chart for a preferred algorithm for inter-cell interference cancellation, although other variants may be used. For a particular receiver, the cells neighboring the receiver's cell are ranked by their received power, step 60. The highest ranked M cells are selected, step 62. P communications to be received by the particular receiver are selected for processing, step 64. Out of the remaining communications for the receiver's cell and the M neighboring cells, N-P communications are selected for processing having the highest code/communication power, step 66. Symbols are jointly detected from the N selected communications, step 68.

One potential implementation of a inter-cell interference canceller receiver is for use in receiving the broadcast channel in the TDD mode of W-CDMA. Typically, more than one base station transmits its broadcast channel in a time slot. As a result, even if efficient radio resource management algorithms are used, the broadcast channels will interfere with each other. An intercell interference canceller receiver can be used to improve reception of the vital broadcast channel.

Another implementation is for use in reception of high speed downlink packet access (HS-DPA). For a cell to efficiently use HS-DPA, resource allocation decisions are made quickly to fully utilize the available HS-DPA resources. Since each cell is making fast allocations, the ability to reduce or minimize interference for the HS-DPA to other cells is reduced, making it desirable to cancel such interference.

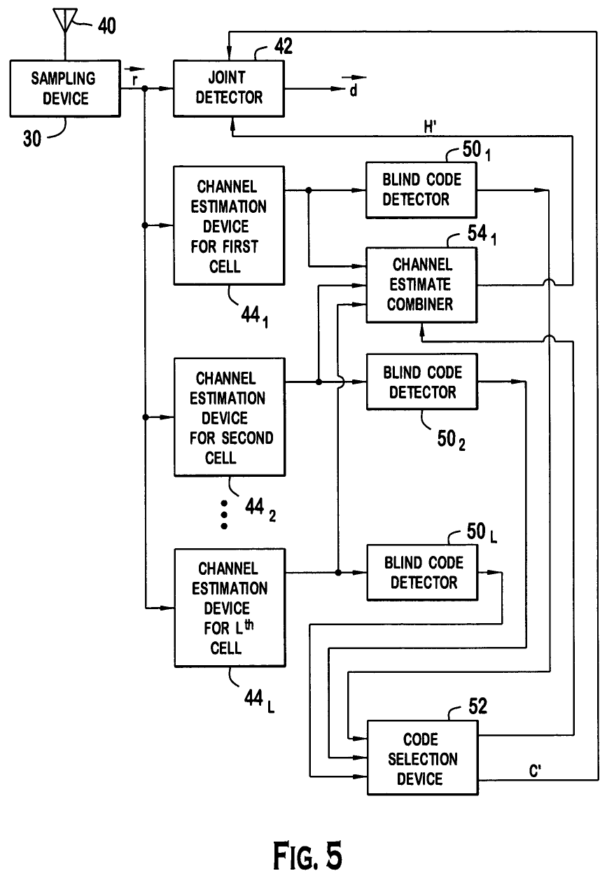

The following is a preferred embodiment for use in conjunction with a 3GPP W-CDMA system utilizing the TDD mode, although aspects are applicable to other wireless systems. FIG. 5 is simplified block diagram illustrating an apparatus for performing intercellular interference cancellation. A signal is received by an antenna 40, and then sampled by a sampling device 30. The received signal samples r are a composite of all of the signals and noise in the spectrum of interest.

The sampled received signal, r, is fed to the input of a joint detector 42, and also to the input of channel estimation devices 44₁, 44₂ . . . 44_{L} (44). In a 3GPP/WCDMA TDD mode, the channel estimation devices 44, preferably utilize an implementation of the Steiner algorithm, although others may be used. The channel estimation devices 44 utilize reference signals, such as a pilot or mid-amble, to provide channel information, such as channel impulse responses as matrices H₁, H₂ . . . H_{L}. Each respective channel estimation devices 44 determines channel estimates for a corresponding cell, preferably as the channel response matrices H₁, H₂ . . . H_{L}.

Outputs of the channel estimation devices are used by corresponding blind code detectors 50₁, 50₂ . . . 50_{L} (50). The blind code detectors 50 determine corresponding code matrices used by a particular cell, C₁ . . . C_{L}. If implemented at a base station, the base station typically would not require a blind code detector 50 for its own cell. The base station would already have this information. Each C₁ . . . C_{L} corresponds to one or more codes that are used in a particular cell. A code selection device 52 selects codes for use in the joint detection. These codes may correspond to codes within the cell or codes used by other cells, as previously described for communications in general. Based on the selected codes, a channel response matrix H′ is produced from the cell channel response matrices H₁, H₂ . . . H_{L}, using only the channel estimates corresponding to the selected rows.

A selected/combined code matrix C′ is inputted into a joint detector 42. which applies the channel response matrices H′ and the code matrices C′ to the sampled received signal r, so as to derive the original transmitted soft symbols, denoted as d.

What is claimed is:

1. A method for receiving at least one desired communication signal in a wireless communication system, the method comprising:
receiving a plurality of communication signals;
selecting communication signals of the plurality of communication signals, the selected communication signals including each desired communication signal and at least one communication signal originating from another cell;
producing a channel estimate for each selected communication signal; and
jointly detecting data of the selected communication signals.

2. The method of claim 1 wherein the selecting of communication signals is based on a received power of each communication signal.

3. The method of claim 2 wherein the selected communication signals have a received power exceeding a threshold.

4. The method of claim 2 wherein the selected communication signals number a fixed value of N.

5. The method of claim 1 wherein the selecting of communication signals is based on a received power of each communication signal per symbol.

6. The method of claim 1 wherein the selecting of communication signals is based on a received power of each communication signal over a specified time period.

7. The method of claim 1 wherein the wireless communication system is a time divided code division multiple access communication system and the producing channel estimates is by implementing a Steiner algorithm for a plurality of cells.

8. The method of claim 7 wherein the time divided code division multiple access communication system is a time division duplex wideband code division multiple access communication system.

9. The method of claim 7 wherein the time divided code division multiple access communication system is a time division synchronous code division multiple access communication system.

10. The method of claim 1 wherein at least one communication signal from another cell includes a communication signal transmitted from one wireless transmit/receive unit for reception by another wireless transmit/receive unit.

11. A wireless transmit/receive unit for receiving at least one desired communication signal, the wireless transmit/receive unit comprising:
means for receiving a plurality of communication signals;
means for selecting communication signals of the plurality of communication signals, the selected communication signals including each desired communication signal and at least one communication signal originating from another cell;
means for producing a channel estimate for each selected communication signal; and
means for jointly detecting data of the selected communication signals.

12. The wireless transmit/receive unit of claim 11 wherein the selecting of communication signals is based on a received power of each communication signal.

13. The wireless transmit/receive unit of claim 12 wherein the selected communication signals have a received power exceeding a threshold.

14. The wireless transmit/receive unit of claim 12 wherein the selected communication signals number a fixed value of N.

15. The wireless transmit/receive unit of claim 11 wherein the selecting of communication signals is based on a received power of each communication signal per symbol.

16. The wireless transmit/receive unit of claim 11 wherein the selecting of communication signals is based on a received power of each communication signal over a specified time period.

17. The wireless transmit/receive unit of claim 11 wherein the received communication signals are in a time divided code division multiple access format and the producing channel estimates is by implementing a Steiner algorithm for a plurality of cells.

18. The wireless transmit/receive unit of claim 17 wherein the time divided code division multiple access format is a time division duplex wideband code division multiple access format.

19. The wireless transmit/receive unit of claim 17 wherein the time divided code division multiple access format is a time division synchronous code division multiple access format.

20. The wireless transmit/receive unit of claim 11 wherein at least one communication signal from another cell includes a communication signal transmitted from one wireless transmit/receive unit for reception by another wireless transmit/receive unit.

21. A wireless transmit/receive unit for receiving at least one desired communication signal, the wireless transmit/receive unit comprising:
an antenna receiving a plurality of communication signals;
a communication selection device selects communication signals of the plurality of communication signals, the selected communication signals including each desired communication signal and at least one communication signal originating from another cell;
a multiple source channel estimation device and a channel estimate selector/combiner produces a channel estimate for each selected communication signal; and
a joint detector jointly detects data of the selected communication signals.

22. The wireless transmit/receive unit of claim 21 wherein the communication selection device selects communication signals is based on a received power of each communication signal.

23. The wireless transmit/receive unit of claim 22 wherein the communication selection device selects communication signals having a received power exceeding a threshold.

24. The wireless transmit/receive unit of claim 22 wherein the communication selection device selects communication signals totaling a fixed number of N.

25. The wireless transmit/receive unit of claim 21 wherein the communication selection device selects communication signals based on a received power of each communication signal per symbol.

26. The wireless transmit/receive unit of claim 21 wherein the communication selection device selects communication signals based on a received power of each communication signal over a specified time period.

27. The wireless transmit/receive unit of claim 21 wherein the received communication signals are in a time divided code division multiple access format and the producing channel estimates is by implementing a Steiner algorithm for a plurality of cells.

28. The wireless transmit/receive unit of claim 27 wherein the time divided code division multiple access format is a time division duplex wideband code division multiple access format.

29. The wireless transmit/receive unit of claim 27 wherein the time divided code division multiple access format is a time division synchronous code division multiple access format.

30. The wireless transmit/receive unit of claim 21 wherein at least one communication signal from another cell includes a communication signal transmitted from one wireless transmit/receive unit for reception by another wireless transmit/receive unit.

31. A base station for receiving at least one desired communication signal, the base station comprising:
means for receiving a plurality of communication signals;
means for selecting communication signals of the plurality of communication signals, the selected communication signals including each desired communication signal and at least one communication signal originating from another cell;
means for producing a channel estimate for each selected communication signal; and
means for jointly detecting data of the selected communication signals.

32. The base station of claim 31 wherein the selecting of communication signals is based on a received power of each communication signal.

33. The base station of claim 32 wherein the selected communication signals have a received power exceeding a threshold.

34. The base station of claim 32 wherein the selected communication signals number a fixed value of N.

35. The base station of claim 31 wherein the selecting of communication signals is based on a received power of each communication signal per symbol.

36. The base station of claim 31 wherein the selecting of communication signals is based on a received power of each communication signal over a specified time period.

37. The base station of claim 31 wherein the received communication signals are in a time divided code division multiple access format and the producing channel estimates is by implementing a Steiner algorithm for a plurality of cells.

38. The base station of claim 37 wherein the time divided code division multiple access format is a time division duplex wideband code division multiple access format.

39. The base station of claim 37 wherein the time divided code division multiple access format is a time division synchronous code division multiple access format.

40. A base station for receiving at least one desired communication signal, the base station comprising:
an antenna receiving a plurality of communication signals;
a communication selection device selects communication signals of the plurality of communication signals, the selected communication signals including each desired communication signal and at least one communication signal originating from another cell;
a multiple source channel estimation device and a channel estimate selector/combiner produces a channel estimate for each selected communication signal; and
a joint detector jointly detects data of the selected communication signals.

41. The base station of claim 40 wherein the communication selection device selects communication signals is based on a received power of each communication signal.

42. The base station of claim 41 wherein the communication selection device selects communication signals having a received power exceeding a threshold.

43. The base station of claim 41 wherein the communication selection device selects communication signals totaling a fixed number of N.

44. The base station of claim 40 wherein the communication selection device selects communication signals based on a received power of each communication signal per symbol.

45. The base station of claim 40 wherein the communication selection device selects communication signals based on a received power of each communication signal over a specified time period.

46. The base station of claim 40 wherein the received communication signals are in a time divided code division multiple access format and the producing channel estimates is by implementing a Steiner algorithm for a plurality of cells.

47. The base station of claim 46 wherein the time divided code division multiple access format is a time division duplex wideband code division multiple access format.

48. The base station of claim 46 wherein the time divided code division multiple access format is a time division synchronous code division multiple access format.

49. A wireless transmit/receive unit for receiving at least one desired communication signal, the wireless transmit/receive unit comprising:
an antenna receiving a plurality of communication signals;
a plurality of channel estimation devices, each channel estimation device for estimating channel responses for a particular cells transmissions;
a plurality of blind code detection devices, each blind code detection devices for detecting codes used in a particular cell;
a code selection device selects codes based on a result of each blind code detection device;
a channel estimate combiner for producing estimated channel responses corresponding to the selected codes; and
a joint detector having inputs configured to receive the selected codes and the produced estimated channel responses and detecting data of the selected communication signals.

50. A base station for receiving at least one desired communication signal, the base station comprising:
an antenna receiving a plurality of communication signals;
a plurality of channel estimation devices, each channel estimation device for estimating channel responses for a particular cells transmissions;
a plurality of blind code detection devices, each blind code detection devices for detecting codes used in a particular cell, excluding a cell of the base station;
a code selection device selects codes based on a result of each blind code detection device and codes of a cell of the base station;
a channel estimate combiner for producing estimated channel responses corresponding to the selected codes; and
a joint detector having inputs configured to receive the selected codes and the produced estimated channel responses and detecting data of the selected communication signals.

51. A method for receiving at least one desired communication signal, the method comprising:
providing a joint detector capable of processing N communication signals;
receiving a plurality of communication signals;
selecting N communication signals of the plurality of communication signals, the selected N communication signals including each desired communication signal and having other communication signal having a highest received power level; the selecting of the N communication signals evaluates communication signals of multiple cells; and
jointly detecting data of the N selected communication signals using the joint detector.

52. The method of claim 11 wherein the selecting N communication signals includes all of the communication signals of a cell of the joint detector.

53. A wireless transmit/receive unit for receiving at least one desired communication signal, the wireless transmit/receive unit comprising:
joint detecting means capable of processing N communication signals;
means for receiving a plurality of communication signals;
means for selecting N communication signals of the plurality of communication signals, the selected N communication signals including each desired communication signal and having other communication signal having a highest received power level; the selecting of the N communication signals evaluates communication signals of multiple cells; and
the joint detecting means for joint detecting data of the N selected communication signals.

54. The wireless transmit/receive unit of claim 53 wherein the selecting N communication signals includes all of the communication signals of a cell of the joint detecting means.

55. A wireless transmit/receive unit for receiving at least one desired communication signal, the wireless transmit/receive unit comprising:
a joint detector capable of processing N communication signals;
an antenna receiving a plurality of communication signals;
a communication selector for selecting N communication signals of the plurality of communication signals signals, the selected N communication signals including each desired communication signal and having other communication signal having a highest received power level; the selecting of the N communication signals evaluates communication signals of multiple cells; and
the joint detector jointly detecting data of the N selected communication signals.

56. The wireless transmit/receive unit of claim 55 wherein the selecting N communication signals includes all of the communication signals of a cell of the joint detector.

57. A base station for receiving at least one desired communication signal, the base station comprising:
joint detecting means capable of processing N communication signals;
means for receiving a plurality of communication signals;
means for selecting N communication signals of the plurality of communication signals, the selected N communication signals including each desired communication signal and having other communication signal having a highest received power level; the selecting of the N communication signals evaluates communication signals of multiple cells; and
the joint detecting means for joint detecting data of the N selected communication signals.

58. The base station of claim 57 wherein the selecting N communication signals includes all of the communication signals of a cell of the joint detecting means.

59. A base station for receiving at least one desired communication signal, the base station comprising:
a joint detector capable of processing N communication signals;
an antenna receiving a plurality of communication signals;
a communication selector for selecting N communication signals of the plurality of communication signals, the selected N communication signals including each desired communication signal and having other communication signal having a highest received power level; the selecting of the N communication signals evaluates communication signals of multiple cells; and
the joint detector jointly detecting data of the N selected communication signals.

60. The base station of claim 59 wherein the selecting N communication signals includes all of the communication signals of a cell of the joint detector.

61. A method for receiving at least one desired communication signal, the method comprising:
providing a joint detector capable of processing N communication signals;
receiving a plurality of communication signals;
selecting at a maximum of N communication signals of the plurality of communication signals, the selected N communication signals including each desired communication signal and having other communication signals having a highest received power level exceeding a threshold value; the selecting of the maximum of N communication signals evaluates communication signals of multiple cells; and
jointly detecting data of the N selected communication signals using the joint detector.

62. A wireless transmit/receive unit for receiving at least one desired communication signal, the wireless transmit/receive unit comprising:
a joint detecting means capable of processing N communication signals;
means for receiving a plurality of communication signals;
means for selecting at a maximum of N communication signals of the plurality of communication signals, the selected N communication signals including each desired communication signal and having other communication signals having a highest received power level exceeding a threshold value; the selecting of the maximum of N communication signals evaluates communication signals of multiple cells; and
the joint detecting means for jointly detecting data of the N selected communication signals using the joint detector.

63. A wireless transmit/receive unit for receiving at least one desired communication signal, the wireless transmit/receive unit comprising:
a joint detector capable of processing N communication signals;
an antenna for receiving a plurality of communication signals;
a communication selector for selecting at a maximum of N communication signals of the plurality of communication signals, the selected N communication signals including each desired communication signal and having other communication signals having a highest received power level exceeding a threshold value; the selecting of the maximum of N communication signals evaluates communication signals of multiple cells; and
the joint detector for jointly detecting data of the N selected communication signals using the joint detector.

64. A base station for receiving at least one desired communication signal, the base station comprising:
a joint detecting means capable of processing N communication signals;
means for receiving a plurality of communication signals;
means for selecting at a maximum of N communication signals of the plurality of communication signals, the selected N communication signals including each desired communication signal and having other communication signals having a highest received power level exceeding a threshold value; the selecting of the maximum of N communication signals evaluates communication signals of multiple cells; and
the joint detecting means for jointly detecting data of the N selected communication signals using the joint detector.

65. A base station for receiving at least one desired communication signal, the base station comprising:
a joint detector capable of processing N communication signals;
an antenna for receiving a plurality of communication signals;
a communication selector for selecting at a maximum of N communication signals of the plurality of communication signals, the selected N communication signals including each desired communication signal and having other communication signals having a highest received power level exceeding a threshold value; the selecting of the maximum of N communication signals evaluates communication signals of multiple cells; and
the joint detector for jointly detecting data of the N selected communication signals using the joint detector.

66. A method for receiving at least one desired communication signal, the method comprising:
receiving a plurality of communication signals;
providing a communication selecting device for selecting communication signals, the communication selecting device selectively operates in a plurality of modes, the modes including a first mode where only communication signals from a cell of the communication selecting device are selected and a second mode where communication signals from multiple cells are potentially selected; and
jointly detecting data of the selected communication signals.

67. A wireless transmit/receive unit for receiving at least one desired communication signal, the wireless transmit/receive unit comprising:
means for receiving a plurality of communication signals;
communication selecting means for selecting communication signals, the communication selecting device selectively operates in a plurality of modes, the modes including a first mode where only communication signals from a cell of the communication selecting device are selected and a second mode where communication signals from multiple cells are potentially selected; and
means for jointly detecting data of the selected communication signals.

68. A wireless transmit/receive unit for receiving at least one desired communication signal, the wireless transmit/receive unit comprising:
an antenna receiving a plurality of communication signals;
a communication selecting device for selecting communication signals, the communication selecting device selectively operates in a plurality of modes, the modes including a first mode where only communication signals from a cell of the communication selecting device are selected and a second mode where communication signals from multiple cells are potentially selected; and
a joint detector jointly detecting data of the selected communication signals.

69. A base station for receiving at least one desired communication signal, the base station comprising:
means for receiving a plurality of communication signals;
communication selecting means for selecting communication signals, the communication selecting device selectively operates in a plurality of modes, the modes including a first mode where only communication signals from a cell of the communication selecting device are selected and a second mode where communication signals from multiple cells are potentially selected; and
means for jointly detecting data of the selected communication signals.

70. A base station for receiving at least one desired communication signal, the base station comprising:
an antenna receiving a plurality of communication signals;
a communication selecting device for selecting communication signals, the communication selecting device selectively operates in a plurality of modes, the modes including a first mode where only communication signals from a cell of the communication selecting device are selected and a second mode where communication signals from multiple cells are potentially selected; and
a joint detector jointly detecting data of the selected communication signals.
